(19) United States
(12) Patent Application Publication
(10) Pub. No.: US 2004/0076933 A1
(43) Pub. Date: Apr. 22, 2004

(54) Chinese spelling input system and method with multimedia Chinese spelling learning function

(76) Inventors: Say-Ling Wen, Taipei (TW); Zechary Chang, Taipei (TW); Leger Wu, Beijing (CN); Back Zhang, Dajie Beijing (CN)

Correspondence Address: BIRCH STEWART KOLASCH & BIRCH, PO BOX 747, FALLS CHURCH, VA, 22040-0747, US

(21) Appl. No.: 10/273,125

(22) Filed: Oct. 18, 2002

(51) Int. Cl. G09B 19/00

(52) U.S. Cl. 434/156; 434/185

(57) ABSTRACT

A Chinese spelling input system and method with the multimedia Chinese spelling learning function is disclosed. Through expandable multimedia learning materials, one can quickly learn the tricks and skills in Chinese spelling input without the limitation of the software platform. The invention further provides a learning process recording function for the user to review learning. The disclosed method includes at least the following steps: starting an input method interface through hot keys, running a learning materials generating module by clicking, the learning materials generating module generating learning materials, and a learning process recording module storing learning data. The disclosed system includes at least an interface function starting module, a learning materials generating module, an output presentation control module, and a learning process recording module.

### BACKGROUND OF THE INVENTION

1. Field of Invention

The invention relates to a Chinese input method (IM) implemented on a computer controllable system platform and, in particular, to a Chinese input system and its method that provides Chinese spelling learning.

2. Related Art

There have been many different innovative ideas and improvements in the evolution of Chinese IM's. However, deeper researches find that these conventional techniques solve the Chinese input speed problem mostly by finding how to perform inputs and selections. For example, many improved designs have been proposed for: (1) word and phrase input method and (2) candidate word and phrase selection. Such designs, nevertheless, usually decrease or shorten the number of mechanical operations by the user. They are unable to totally solve the problem. Without relevant Chinese spelling input learning as the basis, the user often inevitably forgets or even do not know how to correctly input the Chinese due to different dialects and differences between the pronunciations and phonetic spelling. These difficulties make the input process slow or stop. This is the reason why the speed and efficiency of Chinese spelling input are low.

To obtain relevant Chinese spelling basic knowledge or to practice Chinese spelling inputs, users often have to resort to CD titles and books or browsing websites. Not only do these methods cost a lot of time and money, most important of all, they cannot effectively and quickly solve the Chinese spelling input problem. There may even have the software platform problem.

### SUMMARY OF THE INVENTION

In view of the foregoing, the invention proposes a Chinese spelling input system and the corresponding method with the multimedia Chinese spelling learning function. Objectives of the invention include:

1 [symbol] Using the disclosed method, a user can obtain many self-practice courses about Chinese spelling knowledge. The multimedia learning materials in the invention can attract and induce user's interest and motivation by eliminating possible metal obstacles. These courses do not only allow the user to get familiar with tricks and skills in Chinese spelling input more quickly, but also increase the user's input accuracy and speed, promoting the work efficiency. By recording the learning process, the user does not need to waste time learning from the beginning each time. The user can enter the learning materials suitable to his or her level immediately with the help of the learning process record and further learn the obstacles to the learning process as well.

2 [symbol] In addition, since an objective of the multimedia Chinese spelling learning is to solve the differences due to different areas and different culture, the user can learn dialects with different cultural characters during the learning process. Therefore, the invention provides an extra educational function. Of course, the learning materials can be updated or expanded at any time. It allows the user to learn the most up-to-date Chinese spelling, and dialects and cultures at different places.

3 [symbol] The multimedia Chinese spelling learning provided by the invention is included within its IM; therefore, the whole Chinese spelling learning can be performed without the limitation of the software platform. That is, the learning has a wide range, so that more users who need to learn Chinese, spelling input can be benefited from the invention. Through the calling function in the IM, the user can immediately get help for possible questions.

The Chinese spelling IM with the multimedia Chinese spelling learning function provided by the invention includes the following primary steps: starting an IM interface through hot keys, executing a learning materials generating module through clicking, the learning materials generating module generating learning materials, and a learning process recording module storing learning data.

The Chinese spelling input system with the multimedia Chinese spelling learning function provided by the invention includes at least: an interface function starting module, a learning materials generating module, an output presentation control module, and a learning process recording module.

### BRIEF DESCRIPTION OF THE DRAWINGS

The invention will become more fully understood from the detailed description given hereinbelow illustration only, and thus are not limitative of the present invention, and wherein:

FIG. 1 is a functional block diagram of the disclosed Chinese spelling input system with the multimedia Chinese spelling learning function and the method of the same; and

FIG. 2 is an operation flowchart of the disclosed Chinese spelling input system with the multimedia Chinese spelling learning function and the method of the same.

### DETAILED DESCRIPTION OF THE INVENTION

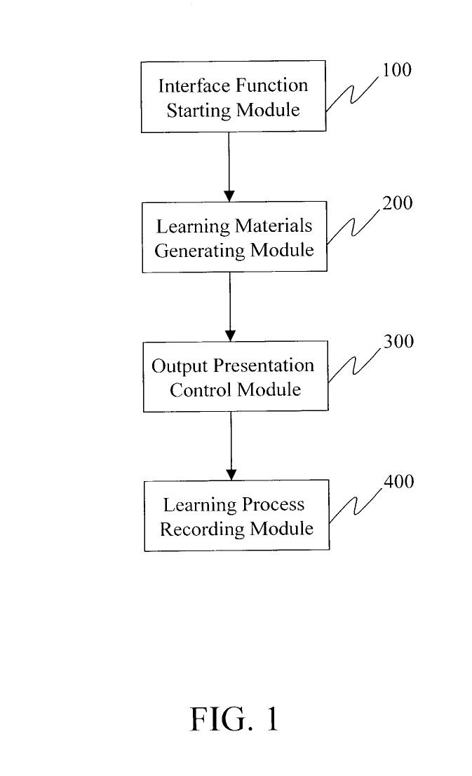

A preferred embodiment is described below to illustrate the feasibility of the invention. With reference to FIG. 1, several important functional elements of the invention are explained as follows:

(1) Interface function starting module 100. The user utilizes the hot key calling function in the input device to generate an IM operational interface. The user can choose to start the without opening any word processing software because the IM operation is independent of the software. Therefore, the user can enter other word processing software, run the IM therein and start any function provided by the IM. There are many functions in the menu bar of the IM interface for the user to select. These of course include the function of Chinese spelling learning. The interface function starting module 100 generates the corresponding function action according to the user's selection.

(2) Learning materials generating module 200. When the user select the Chinese spelling learning function in the IM interface, the learning materials generating module 200 receives the learning function running message transmitted from the interface function starting module 100. After receiving the message, the learning record filenames stored by the user in the past are presented in a pop-up window for the user to select the file suitable to his or her learning progress. Once the user makes a choice, the learning materials generating module 200 generates learning materials corresponding to the contents stored in the record file (the learning materials are presented in a multimedia form, and the multimedia refer to the combination of texts, sounds, pictures, video, etc that can be sensed by human beings). If this is the first time the user uses the Chinese spelling learning function or wants to learn it again, the user can select to cancel the record file selection window and the learning materials generating module 200 generates the learning materials through a random mechanism.

(3) Output presentation control module 300. When the learning materials generating module 200 determines the learning materials, the output presentation control module 300 presents the learning materials through different multimedia forms. The learning process is controlled according to the user's operations (such controls include learning topic selection, learning materials progress selection, offline storage control after learning is completed, etc).

(4) Learning process record module 400. When the user wants to leave the learning function, the output presentation control module 300 produces a data storage message to notify the learning process recording module 400. After receiving the message, the learning process record module 400 asks the user whether the learning record should be stored in a file through, again, a pop-up window. If the user selects to store the learning record, the learning process recording module 400 stores the learning data of the user; otherwise, it quits the storage action and leaves the Chinese spelling learning.

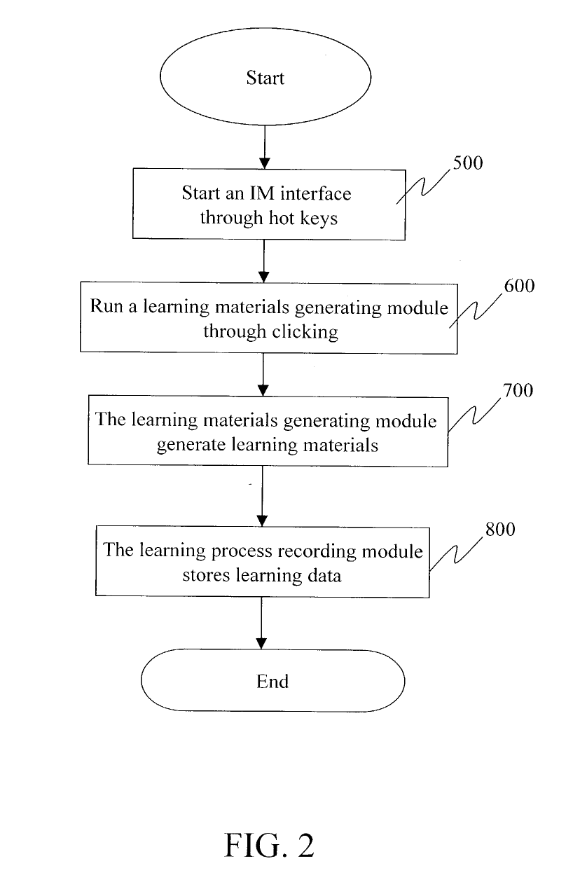

With reference to FIG. 2, it shows the operation flow of the disclosed system and method. In the following, we use the actual process where a user uses other word processing software to perform Chinese spelling learning as an example.

When entering a word processing software program (such as NotePad, WordPad, UltraEdit, Han Editor, etc) and preparing to perform Chinese input, the user calls the function to start IM through predetermined hot keys (step 500). During the input process, the user may have questions about some Chinese inputs (including Chinese spelling input, Chinese phonetic symbol input, etc) and wants to learn more about Chinese spelling input knowledge and skills. The user can thus click the function in the IM interface menu to run the learning materials generating module 200 (step 600). The learning materials generating module 200 displays all learning record files stored by the user in a pop-up window for the user to choose. If the user selects some learning record file, the learning materials generating module 200 automatically generate learning materials through a random selection mechanism (step 700). The presentation of the learning materials thus determined is performed through the output presentation control module 300. The output presentation control module 300 selects a proper way to present the learning materials in multimedia forms (including combinations of texts, sounds, pictures, and videos that can be sensed by human beings). The output presentation control module 300 also performs learning process control according to the user's operations. Such controls include learning topic selection, learning materials progress selection, offline storage control after learning is completed, etc. The learning contents are not always the same. The Chinese spelling learning materials can be updated or expanded through the update function provided by the learning materials generating module 200 at any time. When the user finishes learning or completes some project, the system stores the learning data performed by the user using the learning process recording module 400 (step 800). The system also asks the user whether the learning process should be recorded in a pop-up window. If the user wants to store the record, the learning process recording module 400 stores the data; otherwise, the system leaves the Chinese spelling learning function and returns to the IM interface. The user can continue performing Chinese input in the word processing software. This thus completes the whole Chinese spelling learning procedure.

The Chinese IM mentioned herein can be executed over a variety of digital devices, e.g. 3PC(Personal Computer), NB(Notebook computer), PDA(Personal Digital Assistant), and mobile phone.

The selection input device used in the operation of the invention can be executed using any device selected from group consisting of the combinations of a keyboard, a mouse, a digital touch-control panel and a voice recognition system.

The hot key function used to start the disclosed Chinese IM refers to the key combination selected from the group consisting of number keys 0˜9, English letter keys A˜Z, function keys F1˜F12, and special keys ESC, TAB, PgUp, and END.

Effects of the Invention

Through the disclosed Chinese spelling input system and method, the user can obtain many self-practice courses about Chinese spelling knowledge. For beginners, the multimedia learning materials in the invention can attract and induce their interest and motivation by eliminating possible metal obstacles. Advanced users can quickly familiarize themselves with the tricks and skills in Chinese spelling input, increasing the user's input accuracy and speed and promoting the work efficiency.

By recording the learning process, the user does not need to waste time learning from the beginning each time. The user can enter the learning materials suitable to his or her level immediately with the help of the learning process record and further learn the obstacles to the learning process as well.

In addition, since an objective of the multimedia Chinese spelling learning is to solve the differences due to different areas and different culture, the user can learn dialects with different cultural characters during the learning process. Therefore, the invention provides an extra educational function. Of course, the learning materials can be updated or expanded at any time. It allows the user to learn the most up-to-date Chinese spelling, and dialects and cultures at different places.

The multimedia Chinese spelling learning provided by the invention starts the earning activities through its IM interface; therefore, the whole Chinese spelling learning can be performed without the limitation of the software platform. That is, the learning has a wide range, so that more users who need to learn Chinese spelling input can be benefited from the invention. Through the calling function in the IM, the user can immediately get help for possible questions in mind.

What is claimed is:

1. A Chinese spelling input method with a multimedia Chinese spelling learning function that allows users to learn Chinese spelling input by providing real-time learning materials, the method comprising the steps of:
starting an IM (Input Method) interface through predetermined hot keys;
running a learning materials generating module through a clicking action;
the learning materials generating module generating learning materials; and
a learning process recording module storing learning data.

2. The method of claim 1, wherein the hot keys refer to a key combination.

3. The method of claim 1, wherein the key combination is selected from the group consisting of number keys 0˜9, English letter keys A˜Z, function keys F1˜F12, and special keys ESC, TAB, PgUp, and END.

4. The method of claim 1, wherein the learning materials generating module further provides a learning record file selection function.

5. The method of claim 1, wherein the learning materials present a learning topic in a multimedia form according to a default materials generating mechanism assigned by the learning materials generating module.

6. The method of claim 5, wherein the materials generating mechanism contains at least a random selection mechanism and a learning materials extraction mechanism.

7. The method of claim 5, wherein the learning topic includes at least Roman spelling and phonetic symbol spelling.

8. The method of claim 1, wherein the learning data include at least a learner's name, a learning record filename, a learner's learning process record, and a learning materials progress.

9. A Chinese spelling input system with a multimedia Chinese spelling learning function that allows users to learn Chinese spelling input by providing real-time learning materials, the system comprising:
an interface function starting module, which generates an IM (Input Method) interface through a hot key calling function executed by a user and outputs a learning execution message according to a selection action done by the user;
a learning materials generating module, which receives the learning execution message transmitted from the interface function starting module, starts a learning function to generate learning materials, and sends out a content output message once the learning materials are determined;
an output presentation control module, which receives the content output message sent out from the learning materials generating module to present the learning materials, performs learning process control according to the user's operations, and generates a data storage message; and
a learning process recording module, which performs a learning data storage action according to the data storage message sent out from the output presentation control module.

10. The system of claim 9, wherein the hot keys refer to a key combination.

11. The system of claim 10, wherein the key combination is selected from the group consisting of number keys 0˜9, English letter keys A˜Z, function keys F1˜F12, and special keys ESC, TAB, PgUp, and END.

12. The system of claim 9, wherein the learning materials generating module further provides a learning record file selection function.

13. The system of claim 9, wherein the learning materials generating module further provides a content update and expansion function that adds learning topics and materials at any time.

14. The system of claim 9, wherein the learning materials present a learning topic in a multimedia form according to a default materials generating mechanism assigned by the learning materials generating module.

15. The system of claim 14, wherein the materials generating mechanism contains at least a random selection mechanism and a learning materials extraction mechanism.

16. The system of claim 14, wherein the learning topic includes at least Roman spelling and phonetic symbol spelling.

17. The system of claim 9, wherein the learning process control includes at least learning topic selection control, learning materials progress selection control, and offline storage control after learning is completed.

18. The system of claim 9, wherein the learning data include at least a learner's name, a learning record filename, a learner's learning process record, and a learning materials progress.
